(19) United States
(12) Patent Application Publication
(10) Pub. No.: US 2008/0176588 A1
(43) Pub. Date: Jul. 24, 2008

(54) Method and System for Offloading Mobile-Originating Short Message Traffic

(75) Inventors: Michael Ashdown, Colleyville, TX (US); Steve Lynchard, Sachse, TX (US); Rick Carter, Gainesville, GA (US)

Correspondence Address: David M. O'Dell;Attorney for Applicants, Haynes and Boone, LLP, 901 Main Street, Suite 3100, Dallas, TX, 75202-3789, US

(73) Assignee: SEVIS SYSTEMS, INC., Plano, TX (US)

(21) Appl. No.: 11/683,935

(22) Filed: Mar. 8, 2007

Related U.S. Application Data
(60) Provisional application No. 60/885,563, filed on Jan. 18, 2007.

(51) Int. Cl. H04Q 7/20

(52) U.S. Cl. 455/466

(57) ABSTRACT

A method for managing mobile-originating short messages in a mobile communications network is provided. A request for short message service is identified in a plurality of data link connections. A subscriber is identified for the request for short message service. A radio resource is monitored for the subscriber. Short messages originating from the radio resource are offloaded for the subscriber.

### RELATED CROSS REFERENCE

This application claims priority to U.S. Provisional Patent Application Ser. No. 60/885,563, filed on Jan. 18, 2007, entitled “Method And System For Offloading Mobile-Originating Short Message Traffic,” which is hereby incorporated by reference in its entirety.

### BACKGROUND

This present disclosure relates generally to a mobile communications network and, more particularly, to a system and method for offload mobile-originating short message traffic in a mobile communications network.

In current mobile communications networks, mobile users often subscribe to a short messages service (SMS). SMS allows users to send short messages across the network to other mobile users in a timely fashion. Typically, short messages originating from mobile users are handled by mobile service switching centers (MSCs) in the network. However, the number of MSCs in a mobile communications network is limited. As more and more users subscribe to SMS, a need exists for a method and system that offloads the handling of short message traffic from MSCs in the mobile communications network.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. It is also emphasized that the drawings appended illustrate only typical embodiments of this invention and are therefore not to be considered limiting in scope, for the invention may apply equally well to other embodiments.

FIG. 1 is a block diagram of an exemplary mobile communications network.

FIG. 2 is a block diagram of a system for offloading mobile-originating short message traffic.

FIG. 3 is a diagram illustrating interactions between L2 Abis platform, SIF, SMSRF and other network entities in mobile communications network 200.

FIG. 4 is a flowchart of a process for offloading MO-SM traffic.

FIG. 5 is a flowchart of a process for identifying the subscriber from the perspective of the L2 Abis platform.

FIG. 6 is a flowchart of a process for identification of subscriber from the perspective of the SIF.

FIG. 7 is a flowchart of a process for performing SendIdentication Request by the SIF.

FIG. 8 is a flowchart of a process for adding a subscriber performed by SIF.

FIG. 9 is a flowchart of a process for removing a subscriber performed by the SIF.

FIG. 10 is a flowchart of a process for a periodic update of records in the data store by the SIF.

FIG. 11 is a flowchart to a process for monitoring radio resource.

FIG. 12 is a flowchart of a process for short message routing function.

FIG. 13 is a flowchart of a process for releasing radio resource monitoring.

### DETAILED DESCRIPTION

For the purposes of promoting an understanding of the principles of the invention, reference will now be made to the embodiments, or examples, illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. Furthermore, the depiction of one or more elements in close proximity to each other does not otherwise preclude the existence of intervening elements. Also, reference numbers may be repeated throughout the embodiments, and this does not by itself indicate a requirement that features of one embodiment apply to another embodiment, even if they share the same reference number.

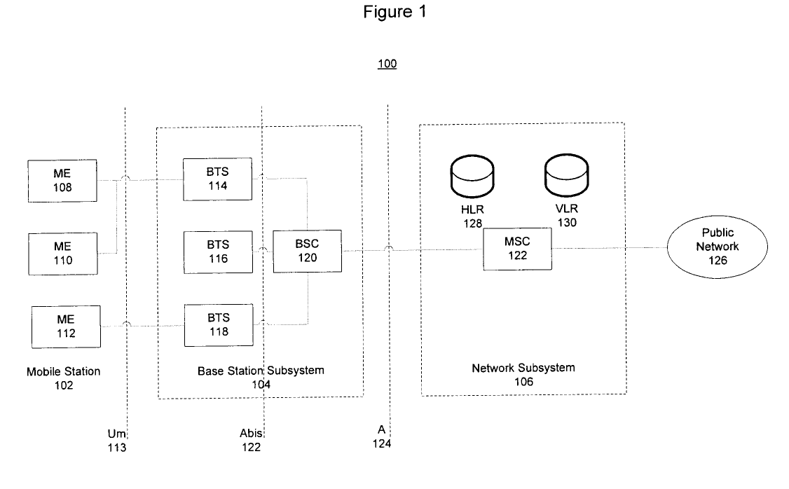

Referring to FIG. 1, a mobile communications network 100 is one example of a system that can benefit from the present invention. The mobile communications network 100 comprises three functional entities: mobile stations 102, a base station subsystem 104, and a network subsystem 106. The mobile stations entity 102 includes one or more mobile stations with mobile equipment (ME), such as MEs 108, 110, 112, carried by subscribers. Examples of mobile stations include cellular telephones, portable computers, and personal digital assistants. In some embodiments, subscribers may place voice calls, transmit/receive data, and/or send short messages from their respective mobile station. Each ME is uniquely identified, such as by an international mobile equipment identity (IMEI), and includes a subscriber identifier, such as a subscriber identity module (SIM) card. A SIM card provides user access to the subscribed services irrespective of a specific terminal. To identify the subscriber, a SIM card comprises an international mobile subscriber identify (IMSI), a secret key for authentication, and other information. IMEI and IMSI are independent from one another.

The base station subsystem 104 controls the radio link with the mobile stations 102. The base station subsystem 104 comprises base transceiver stations (BTSs) and base station controllers (BSC). BTS houses radio transceivers (TRX) that define a cell and handles radio link protocol with the mobile stations 102. Each BTS may handle radio links for one or more mobile equipment devices across a Um interface 113. For example, BTS 114 handles radio links for ME 108 and 110, while BTS 118 handles radio links for ME 112. BTSs, such as BTS 114 and 118, communicate with BSC 120 across a standard, or vendor proprietary Abis interface 122, which allows communications between MEs, that are made by different vendors, and the BSC 120.

BSC 120 manages radio resources for one or more BTSs. BSC 120 handles radio-channel setup, frequency hopping, handovers, etc. BSC 120 provides communications between the mobile stations 102 and the mobile service switching center (MSC) 122 of the network subsystem 106. BSC 120 communicates with MSC 122 across an A interface 124.

MSC 122 in network subsystem 106 performs switching of calls or data between mobile users, and between mobile and fixed telephony network. MSC 122 acts as a node of a public network 126, such as PLMN, ISDN, or PSTN. MSC 122 provides all the functionality necessary to handle a mobile subscriber, including registration, authentication, location updating, handovers, and mobility management operations. Signalling between functional entities in the network subsystem 106 uses signaling system number 7 (SS7), which is widely used for trunk signaling in ISDN and other public networks.

Network subsystem 106 also comprises a home location register (HLR) and visitor location register (VLR) for enabling MSC's call routing and roaming capabilities. HLR 128 comprises information of each subscriber registered in the network 100 and the current location of the ME. VLR 130 comprises selected information from the HLR 128 for each ME currently located in the geographical area controlled by the VLR 130. In most implementations, VLR 130 is associated with a MSC 122 to store information of MEs that are in the geographical area controlled by the MSC 122.

Currently, when mobile users send short messages from MEs, the messages are handled by MSC 122, which forwards the messages to the appropriate destination. However, as the number of MSCs is limited in a network, aspects of the present disclosure provides a method and system for offloading mobile-originating short messages before the messages reach the MSC and forwards the messages to the appropriate destination.

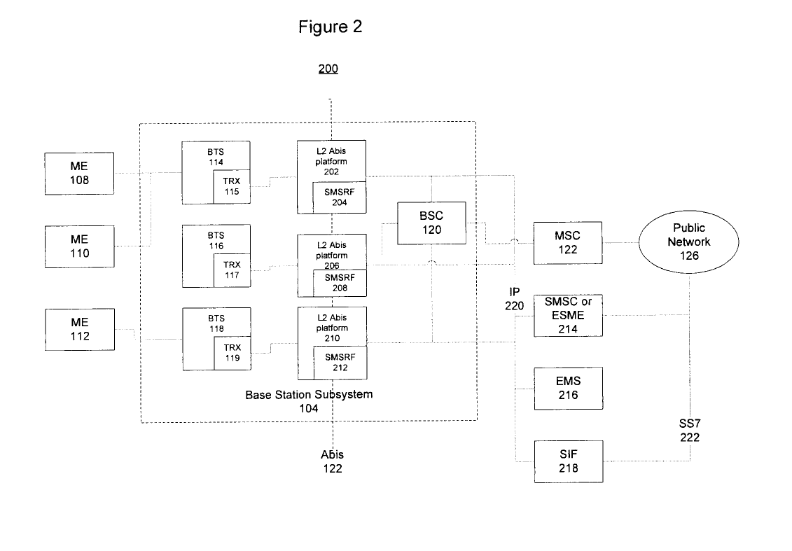

Referring to FIG. 2, a mobile communications network 200 comprises similar functional entities as the mobile communications network 100 in FIG. 1. In addition, mobile communications network 200 provides a layer 2 (L2) Abis platform between each transceiver (TRX) of BTS and BSC 120. For example, L2 Abis platform 202 is provided between TRX 115 of BTS 114 and BSC 120, L2 Abis platform 206 is provided between TRX 117 of BTS 116 and BSC 120, and L2 Abis platform 210 is provided between TRX 119 of BTS 118 and BSC 120.

The L2 Abis platform 202, 206, or 210 is an link access protocol channel-D (LAPD) network element that is capable of establishing, monitoring, and releasing radio resources for each mobile station (L2 links on the radio path) and supports data link traffic between TRX of BTS and the BSC. LAPD is a layer 2 protocol in the integrated service digital network (ISDN) suite that carries signals and data packets between the user and the network. LAPD works in an asynchronous balanced mode (ABM).

In order to support level 3 traffic between TRX of BTS and BSC, the L2 Abis platform must be able to encode and decode layer 3 messages on top of the layer 2 data link and transparently add or remove these messages from the LAPD data link connections. In one embodiment, L2 Abis platforms 202, 206, and 210 may be implemented as a transparent LAPD device that maintains L2 status of the TRX and BSC. In this embodiment, L2 Abis platforms 202, 206, and 210 are not fully functional L2 nodes. Instead, L2 Abis platforms 202, 206, and 210 are L2 devices that intercept L2 messages between the TRX of the BTS and the BSC. Thus, rather than terminating L2 messages at the L2 Abis platform network node, the messages are merely intercepted and forwarded to either the TRX of the BTS or BSC. In this embodiment, all L2 supervisory, unnumbered, and information transfer commands terminate at the end nodes and are not directly terminated with the L2 Abis platforms 202, 206, and 210.

In an alternative embodiment, the L2 Abis platforms 202, 206, and 210 may be implemented as devices supporting terminal endpoint (TE) and network LAPD nodes bridging the L2 supervisory, unnumbered, and information transfer commands. In this embodiment, L2 Abis platform 202, 206, and 210 are fully functional L2 network nodes that terminate data links.

Within each L2 Abis platform, a short message service routing function (SMSRF) is provided. For example, SMSRF 204 is provided within L2 Abis platform 202, SMSRF 208 is provided within L2 Abis platform 206, and SMSRF 212 is provided within L2 Abis platform 210. In addition to being part of the L2 Abis platform, SMSRF may be implemented as an independent module accessible remotely via a protocol such as transmission control protocol/internet protocol (TCP/IP).

SMSRF 204, 208, and 212 provide transport of mobile-originating short messages based on routing tables utilizing key values within the relay and transport protocols. When routing short messages to the appropriate destination, SMSRF 204, 208, and 212 communicate with short message service center (SMSC) or external short message entity (ESME) 214 via an IP link 220. SMSC 214 stores short messages originating from the mobile stations and forwards the messages to the appropriate destination. When forwarding messages, SMSC 214 communicates with public network 126 via an SS7 network link.

In order to provide offloading service to the correct subscribers, a subscriber identification function (SIF) 218 is provided. SIF 218 maintains a list of subscribers for the mobile-originating short message service (MO-SMS). For each subscriber, SIF 218 collects and stores correlations between international mobile subscriber identity (IMSI), temporary mobile subscriber identity (TMSI), and mobile station integrated service digital network (MSISDN) number along with authentication sets. TMSI is a random number assigned to the mobile station by the serving VLR every time the mobile station moves to a geographical area served by a different VLR. MSISDN is a standard international telephone number used to identify a given subscriber.

When a subscriber's TMSI is received from the L2 Abis platform for the short message service initiated by the mobile station, SIF 218 determines if the MO-SMS is enabled for the subscriber. If the service is enabled, SIF 218 returns the subscriber's identification information for authentication and offload service to the L2 Abis platform. When obtaining identification information, SIF 218 communicates with the public network 126 via an SS7 network link 222.

Since the L2 Abis platform is a LAPD network element, specifications may require that an element management server (EMS) 216 provide fault management, configuration management, accounting, performance management, and security (FCAPS) service of the L2 Abis platform.

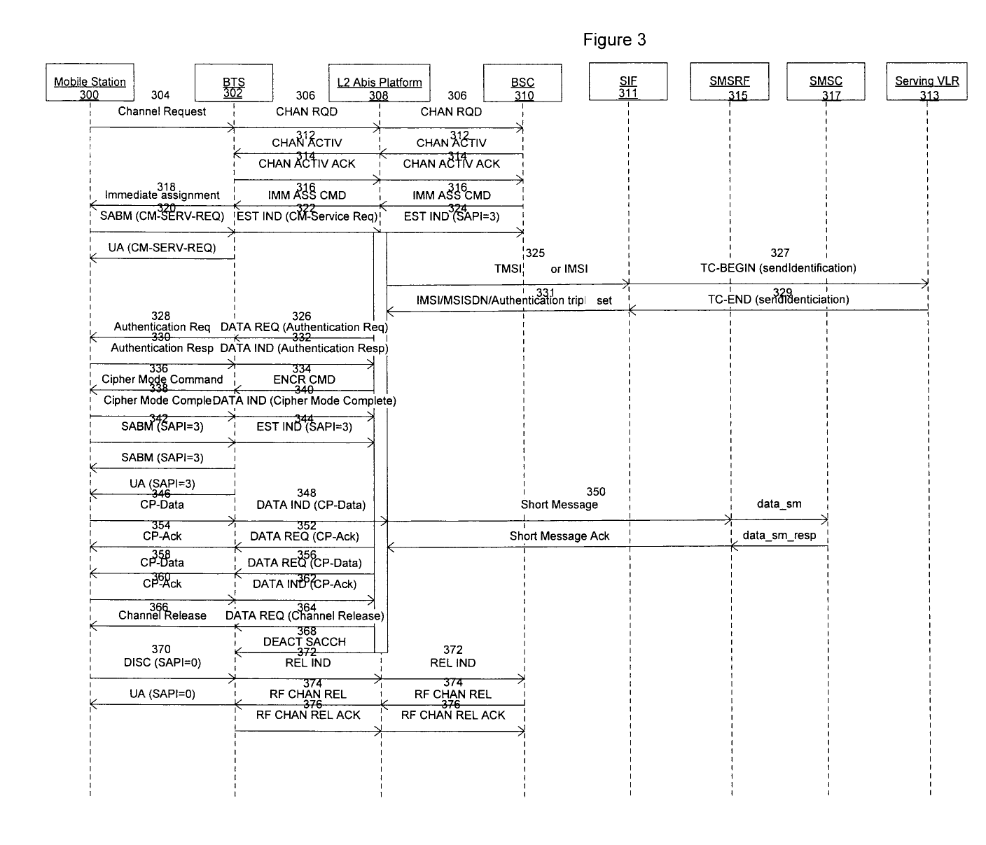

Referring to FIG. 3, a sequence of messages begins when mobile station 300 initiates a mobile-originating short message (MO-SM). In the present example, no dedicated control channel (DCCH) is active, so mobile station 300 places a channel request message 304 on a random access channel (RACH). When BTS 302 receives the channel request message 304, BTS 302 places the message on the Abis interface as a layer 2 (L2) information (I) frame containing a transparent layer 3 (L3) CHAN RQD message 306. The L2 Abis platform 308 passes the L3 CHAN RQD message 306 to BSC 310 allowing it to set up an appropriate dedicated control channel (DCCH) with the BTS 302.

During setup of the DCCH, the BSC 310 responds to the CHAN RQD message 306 by transporting a non-transparent layer 3 (L3) CHAN ACTIV message 312 on a layer 2 (L2) information (I) frame. The L2 Abis platform 308 forwards the CHAN ACTIV message 312 to the BTS 302 to activate the DCCH. If the BTS 302 is capable of activating the DCCH, BTS 302 responds with a non-transparent L3 CHAN ACTIV ACK message 314 containing the current radio interface frame number on a L2 I frame. The L2 Abis platform in turn forwards the L3 CHAN ACTIV ACK message 314 to the BSC 310 to set up the appropriate DCCH.

Next, BSC 310 sends a non-transparent L3 IMM ASSIGN CMD message 316 on a L2 I frame. The L2 Abis platform 308 passes the L3 IMM ASSIGN CMD message 316 to BTS 302, which is placed on the access grant channel (AGCH) by the BTS 302. An immediate assignment message 318 is sent by the BTS 302 to setup the DCCH for the mobile station 300. When the mobile station 300 receives the immediate assignment message 318, the mobile station sets up a multiframe LAPDm data link by sending a set asynchronous balance multiframe (SABM) L2 message 320 containing a connection management service request (CM-SERV-REQ). LAPDm is a modified version of the LAPD protocol used in ISDN across the Um interface, the interface between the mobile station 300 and the BTS 302. The CM-SERV-REQ identifies a service requested by the subscriber of the mobile station 300. BTS 302 receives the SABM L2 message 320 on the channel and timeslot allocated within the IMM ASSIGN CMD message 316 broadcasted on the AGCH and bundles the CM-SERV-REQ within an EST IND message 322 as an optional information element (IE) within a L2 frame.

The L2 Abis platform 308 intercepts the L3 EST IND message 322 with the optional L3 information element containing the CM-SERV-REQ and analyzes the CM-SERV-REQ to determine if the service request is for the short message service. If the service request is for the short message service, the L2 Abis platform 308 removes the CM-SERV-REQ from the bundle and sends the EST IND message 324 with the Link Identifier information element SAPI value set to three (SAPI=3) to BSC 310. At this time, the L2 Abis platform 308 tags the specific radio resource using a combination of channel number, link identifier, and TRX address as a radio resource of interest and monitors all message traffic between the BSC 310 and the MS 300 for the radio resource of interest. Thus, the L2 Abis platform 308 has successfully identified the initiating of the mobile-originating short message service for a subscriber.

When the BSC 310 receives the EST IND message 324, BSC 310 either waits for additional information or immediately sets up a signaling connection control part (SCCP) connection with the MSC. Either behavior is acceptable for the BSC 310 since the TMSI or IMSI of the mobile station is required before MSC 122 initiates mobile management procedures. The L2 Abis platform 308 then initiates authentication and mobility management procedures with the mobile station 300. To authenticate the subscriber, the L2 Abis platform 308 sends the subscriber's TMSI or IMSI 325 to the subscriber identification function (SIF) 311 for a lookup of subscriber identification information. The SIF 311 performs a lookup of the subscriber in the data store or sends a send_Identification request 327 to a serving VLR 313 for the subscriber identification set. The serving VLR 313 returns the IMSI and authentication sets 329 to the SIF 311. The MSISDN may be obtained via a OAM&P system or by monitoring HLR to VLR MAP procedures. The SIF 311 then returns the set of subscriber identification 331 including the IMSI, MSISDN, and the authentication set to L2 Abis platform 308, which in turn sends an authentication request to the BTS 302. The authentication request is sent as a complete L3 message packaged within a transparent L3 DATA REQ message 326 on the Abis interface within a L2 I frame. The BTS 302 forwards the authentication request 328 to the mobile station 300. The mobile station 300 responds to the request with an authentication response 330. The BTS 302 passes the authentication response to the L2 Abis platform 308 as a L3 information element within a transparent L3 DATA IND message 332 on a L2 I frame. The L2 Abis platform 308 intercepts this message and completes the authentication procedure. If authentication is unsuccessful, the L2 Abis platform 308 terminates monitoring of the radio resource of interest and passes the original CM-SERV-REQ to the BSC 310.

However, if the authentication is successful, the L2 Abis platform 308 initiates encryption operations. Encryption operation may be configured ahead of time by the operator. If encryption is configured, the L2 Abis platform 308 sends a non-transparent L3 ENCR CMD message 334 within an L2 I frame to the BTS 302. The ENCR CMD message 334 contains a complete cipher mode command 336 for the BTS 302 to transmit on the radio interface to the mobile station 300. In response, the mobile station 300 sends a cipher mode complete message 338 to BTS 302. BTS 302 passes the cipher mode complete message 338 on the Abis interface as a transparent L2 DATA IND message 340 transported on a L2 I frame. The L2 Abis platform 308 intercepts the DATA IND message 340 and prevents it from being passed to the BSC 310. Thus, the mobility management and radio resource control procedures are now complete and a data link for short message service has been established.

The data link for short message service is completed by the mobile station 300 sending a SABM message 342 including a SAPI=3 identifying a short message service request to the network across the DCCH. The BTS 302 establishes the short message connection management data link by sending an EST IND message 344 including a SAPI=3 within a L2 I frame to the BSC 310. The L2 Abis platform 308 once again intercepts this message and prevents it from reaching the BSC 310.

Next, the mobile station 300 sends a mobile-originating short message (MO-SM) via a CP-Data message 346. The BTS 302 passes the CP-Data message to the BSC 310 as a transparent L2 DATA IND message 348 containing the CP-Data within a L2 I frame. To offload the message, the L2 Abis platform 308 intercepts the DATA IND message 348 and passes the short message 350 to its appropriate destination using the short message service routing function (SMSRF) 315. The short message 350 is passed along with additional information collected from external sources, such as the short message service center (SMSC) 317, or by monitoring additional messages on the Abis interface.

If the short message is delivered successfully, the L2 Abis platform 308 acknowledges the receipt of the short message by sending a transparent L3 DATA REQ message 352 containing a CP-Ack to BTS 302. BTS 302 passes the CP-Ack message 354 to the mobile station 300. The CP-Ack message 354 is followed by a CP-Data message sent by the L2 Abis platform 308 as a transparent L3 Data REQ message 356 containing the CP-data within a L2 I frame to the BTS 302. The BTS 302 forwards the CP-Data message 358 to the mobile station 300. A final acknowledge is sent by the mobile station 300 as a CP-Ack message 360 to the BTS 302, which forwards the message on the Abis interface as a transparent L3 DATA IND message 362 containing the CP-Ack within a L2 I frame. Other mobile-originating short messages may also be sent by the mobile station 300 utilizing messages 346-362 and the L2 Abis platform 308 processes each message in sequence.

After all the mobile originated short messages are sent, the L2 Abis platform 308 frees up the radio resources by sending a transparent L3 DATA REQ message 364 containing a channel release within a L2 I frame to the BTS 302. The BTS 302 forwards the channel release message 366 to the mobile station 300. In addition, the L2 Abis platform 308 informs the BTS 302 to deactivate the slow-associated control channel (SACCH) of the active channel by sending a non-transparent L3 DEACT SACCH message 368 within a L2 I frame to the BTS 302. When the mobile station 300 receives the channel release message 366, it disconnects the LAPDm data link between the mobile station 300 and the BTS 302 by sending a DISC message 370 containing SAPI=0 (for radio resource management signaling) to the BTS 302. The BTS 302 then sends a non-transparent L3 REL IND message 372 to the BSC 310 which is forwarded by the L2 Abis platform 308.

When BSC 310 receives the REL IND message 372, BSC 310 responds with a non-transparent L3 RF CHAN REL message 374 within a L2 I frame to the BTS 302 notifying it that the radio channel is no longer needed. The RF CHAN REL message 374 is passed by the L2 Abis platform 308 to the BTS 302. The BTS 302 deactivates the channel and frees up resources and sends a RF CHAN REL ACK 376 to the BSC 310. It is noted that while the radio resource is utilized by the L2 Abis platform 308, incoming messages from the mobile station 300 and the BSC 310 are monitored for the radio resource in use. These messages are queued by the L2 Abis platform 308 and passed to the BSC 310 or MS 300 after the MO-SM is offloaded. While the incoming messages are queued, the radio resource is not deactivated and the messages are forwarded to the appropriate node. The MSC may initiate the mobility management and radio resource control procedures without knowing that the L2 Abis platform 308 already performs these procedures for the radio resource. The MSC procedures may occur at any time while there is an active connection between MSC and the MS 300.

L2 Abis platform

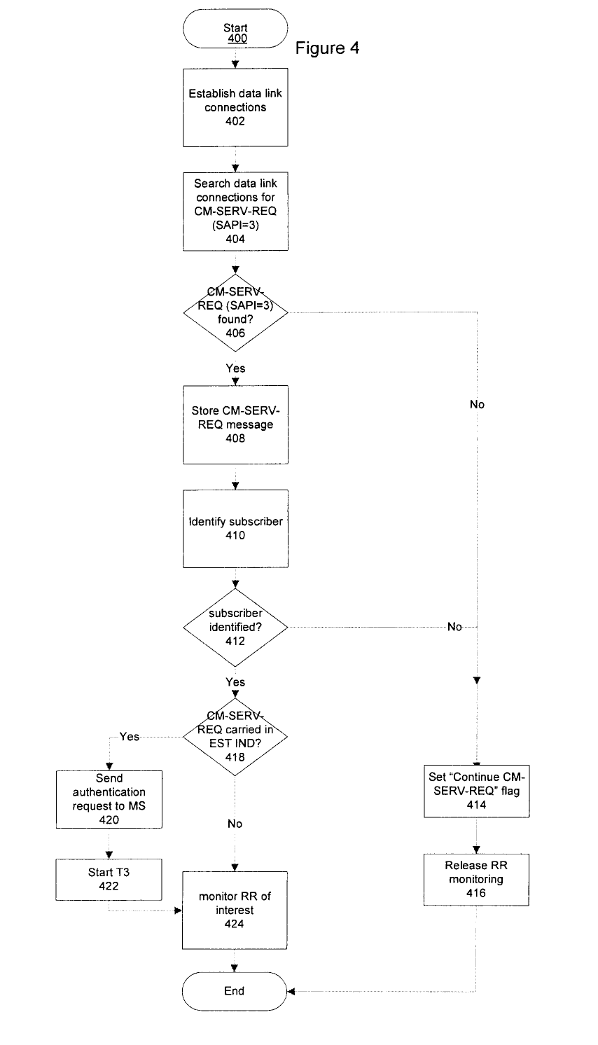

As discussed above, the system for offloading MO-SMS comprises the L2 Abis platform, which is capable of establishing, monitoring, and releasing radio resources. In addition, the L2 Abis platform is capable of intercepting and rerouting the MO-SMS traffic from the radio resource of interest. Referring to FIG. 4, process 400 for offloading the MO-SMS traffic begins at step 402 to establish data link connections between the BSC and the TRX of the BSC.

In one embodiment, the L2 Abis platform may be implemented as a transparent LAPD device that maintains L2 status of the TRX and BSC. In this embodiment, the L2 Abis platform is not a fully functional L2 node. Instead, L2 Abis platform is a L2 device that intercepts L2 messages between the TRX of the BTS and the BSC. Thus, rather than terminating L2 messages at the L2 Abis platform network node, the messages are merely intercepted and forwarded to either the TRX of the BTS or BSC. In this embodiment, all L2 supervisory, unnumbered, and information transfer commands terminate at the end nodes and are not directly with L2 Abis platform. In an alternative embodiment, the L2 Abis platform may be implemented as devices supporting terminal endpoint (TE) and network LAPD modes bridging the L2 supervisory, unnumbered, and information transfer commands. In this embodiment, L2 Abis platform is a fully function L2 network node that terminates data links.

In both embodiments, a separate set of sequence numbers are maintained between the L2 Abis platform and the BSC and between the L2 Abis platform and the BTS. The L2 Abis platform may act as a network node to the BTS or a terminal endpoint (TE) node to the BSC. Sequence numbers are used for ordering of frames between nodes. The L2 Abis platform translates and modifies LAPD data appropriately, for example, setting the C/R bit, address fields, and control octets. In addition, the L2 Abis platform supports both A and B frame formats, unnumbered information (UI) and information (I) frames. Furthermore, termination endpoint identifiers and other relevant data are provisioned by the L2 Abis platform.

Since a separate set of sequence numbers are maintained, the L2 Abis platform may modify, add, and delete messages without causing interruptions with the end nodes. These abilities enable the L2 Abis platform to search and control data connections for specific radio resources. As an active layer 2 device, the L2 Abis platform may manage the data link connections (which occurs at layer 2) while providing complete access to the radio resources (which occurs at layer 3).

Once the data link connections are established, process 400 continues to step 404 to search the data link connections for a CM-SERV-REQ message with SAPI=3. The CM-SERV-REQ message contains a mandatory information element (IE) named CM service type. This IE identifies the SAPI, which is defined as 3 for short message service. The L2 Abis platform searches for the CM-SERV-REQ message either in a L3 transparent EST IND or DATA IND message, which is transported within a L2 I frame. In addition, the L2 Abis platform may decode messages to determine the direction, message type and SAPI value.

In this embodiment, the decoding function may be implemented as software, with full or partial decode, or firmware using byte offsets and simple compares. The EST IND or DATA IND message includes fixed length mandatory information elements (IEs) with the L3 information IE located “last” in the message. The L3 information IE is variable length and contains the CM-SERV-REQ message. Within this IE, the message type and service type are fixed length and organized before any variable length IE. Since the IEs of interest are fixed length and located before any variable length IE, the byte offsets are consistent.

Process 400 continues to step 406 to determine whether a CM-SERV-REQ message with a SAPI=3 is found. If the message is not found, process 400 continues to step 414 to set “Continue CM-SERV-REQ” flag. If the message is found, process 400 continues to step 408 to store the CM-SERV-REQ message. In case of failure conditions, the stored message is placed back on the Abis interface for processing by the MSC. This failure recovery is referred to as “failing to the MSC”. “Failing to the MSC” allows the L2 Abis platform to gracefully support failure conditions without impacting the short message service for a subscriber. The “failing to the MSC” capability may be enabled or disabled by the operator.

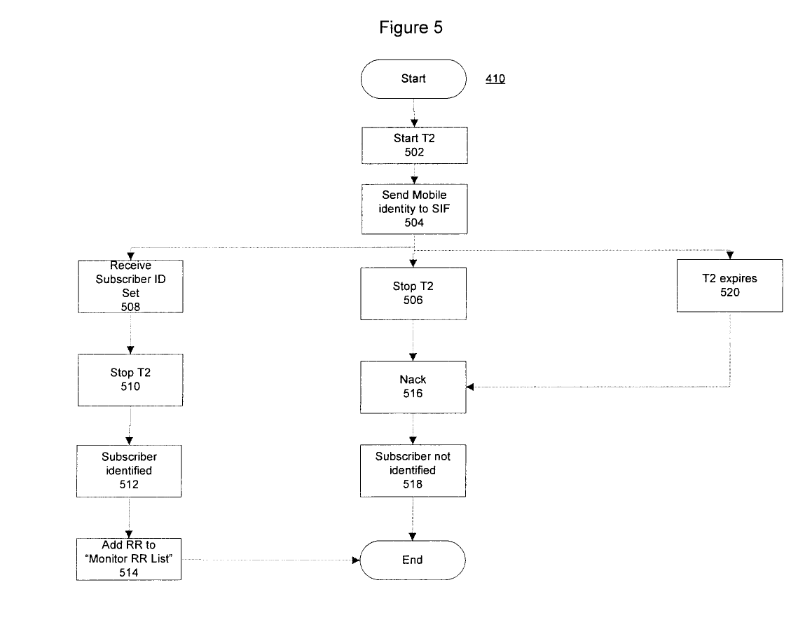

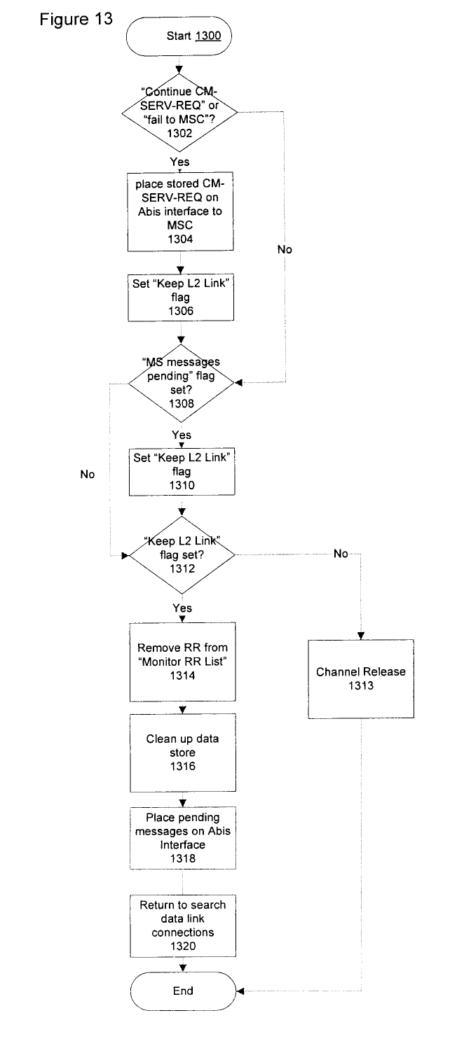

Once the message is stored, process 400 continues to step 410 identify the subscriber and a determination is made at step 412 to determine if the subscriber is identified. More details regarding identification of subscriber are discussed with reference to FIGS. 5-10 below. If the subscriber is not identified, process 400 continues to step 414 to set the “Continue CM-SERV-REQ” flag. The “Continue CM-SERV-REQ” flag indicates that a failure had occurred and that the stored CM-SERV-REQ message may “fail to the MSC”. After the “Continue CM-SERV-REQ” flag is set, process 400 continues to step 416 to release radio resource (RR) monitoring. Release radio resource monitoring releases a specific radio resource when monitoring is no longer required, either due to successful offloading of the MO-SM or an error. More details regarding release RR monitoring are discussed in FIG. 13 below.

However, if the subscriber is identified at step 412, process 400 continues to step 418 to determine if the CM-SERV-REQ message is carried within the EST IND message. If the CM-SERV-REQ message is not carried within the EST IND message, process 400 continues to step 424 to monitor the radio resource of interest. If the CM-SERV-REQ message is carried within the EST IND message, process 400 continues to step 420 to send authentication request to the mobile station. The authentication request is sent as a layer 3 (L3) message to the mobile station. This message contains information regarding which Kc to use along with RAND challenge. The subscriber identification function (SIF) provides the L2 Abis platform with the RAND along with the RAND encrypted by Ki within the subscriber identification set.

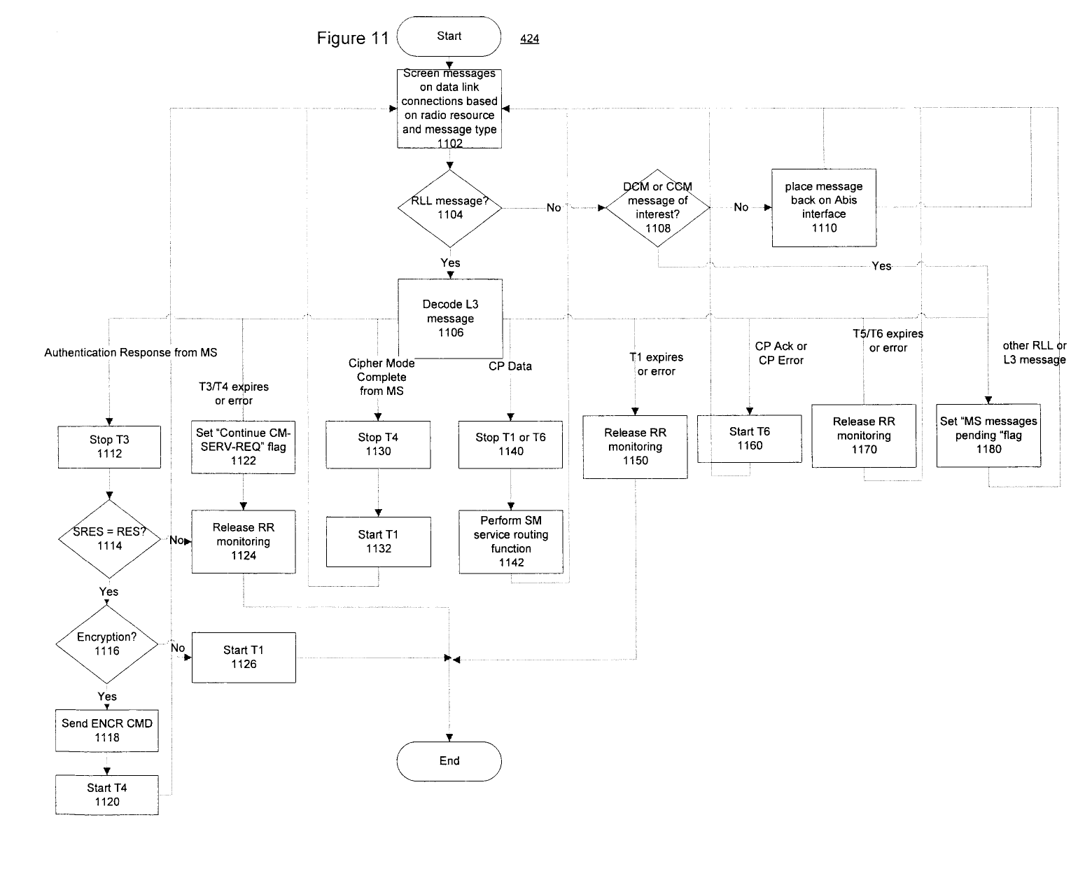

Process 400 continues to step 422 to start a timer 3 (T3). T3 is used for timing authentication response from the mobile station. Process 400 then continues to step 424 to monitor the radio resource of interest. More details regarding monitoring the radio resource of interest are discussed with reference to FIG. 11 below.

In order for the L2 Abis platform to perform offloading of MO-SM, the correct subscriber must be identified. In one embodiment, the set of subscriber identification used to identify a subscriber includes a TMSI, a IMSI, an authentication set, a MSISDN, a SMS offloading service type, and an encryption flag.

The subscriber's identity in the CM-SERV-REQ message may be identified by TMSI or IMSI. TMSI is typically used for security reasons on the radio interface. TMSI is set by the VLR and does not uniquely identify a subscriber across wireless networks. Thus, the L2 Abis platform must also identify the subscriber's MSISDN as this information must be included in the offloaded MO-SM. Once the subscriber's identity is determined, the L2 Abis platform may perform authentication to positively identify the subscriber.

Referring to FIG. 5, process 410 for identifying the subscriber from the perspective of the L2 Abis platform begins at step 502 to start a timer 2 (T2). T2 is used for timing subscriber identification performed by the subscriber identification function (SIF). T2 is set before a query for subscriber identification set is sent to the SIF to protect against abnormal latency and to ensure that the L2 Abis platform may “fail to the MSC” without causing the MO-SMS timeouts on the mobile station. Process 410 then continues to step 504 to send a mobile identity to the SIF. The mobile identity is included in the CM-SERV-REQ message and is either a TMSI or a IMSI.

Once the mobile identity is sent, one of the following conditions occurs: a subscriber ID set (step 508) received from SIF, a stop timer 2 (T2) (step 506), or timer T2 expires (step 520). The subscriber ID set is used during authentication procedures while the MSISDN and the IMSI are used to form the MO-SM over IP message. When an error condition has occurred or that the mobile originated short message offload service is not active for the given subscriber, timer 2 is stopped (step 506) and a Nack is returned (step 516). The expiration of T2 (step 520) results in a failure condition and a Nack is also returned (step 516). When a Nack is returned from either case, the subscriber has not been identified (step 518) and the MO short message is not offloaded for the subscriber.

If a subscriber ID set is received from the SIF at step 508, process 410 continues to step 510 to stop timer 2 (T2) since a response from the SIF has been received. At this time, the subscriber has been identified at step 512 and process 410 continues to step 514 to add the specific radio resource to the “monitor RR list”.

### Subscriber Identification Function (SIF)

The subscriber identification function maintains a list of subscribers for the MO-SM offloading service. The SIF may be described as a relational database that associates TMSI with the subscriber's IMSI and MSISDN. Since the access domain is designed to minimize the use of IMSI and does not use the MSISDN, the SIF provides this information to the L2 Abis platform. In addition to IMSI and MSISDN, the SIF also maintains the authentication sets for the subscriber. The L2 Abis platform sends a subscriber's TMSI to the SIF and if the MO-SMS service is enabled for the subscriber, the SIF returns the subscriber identification set. In turn, the L2 Abis platform uses the subscriber identification set to authenticate the subscriber and offload the short message. The authentication sets are required and may be obtained from the VLR, HLR or generated from the Ki. The MSISDN is provisioned via the operations, administration, maintenance, and provisioning (OAM&P) procedures or collected from the InsertSubscriberData MAP operation sent to the serving VLR from the HLR.

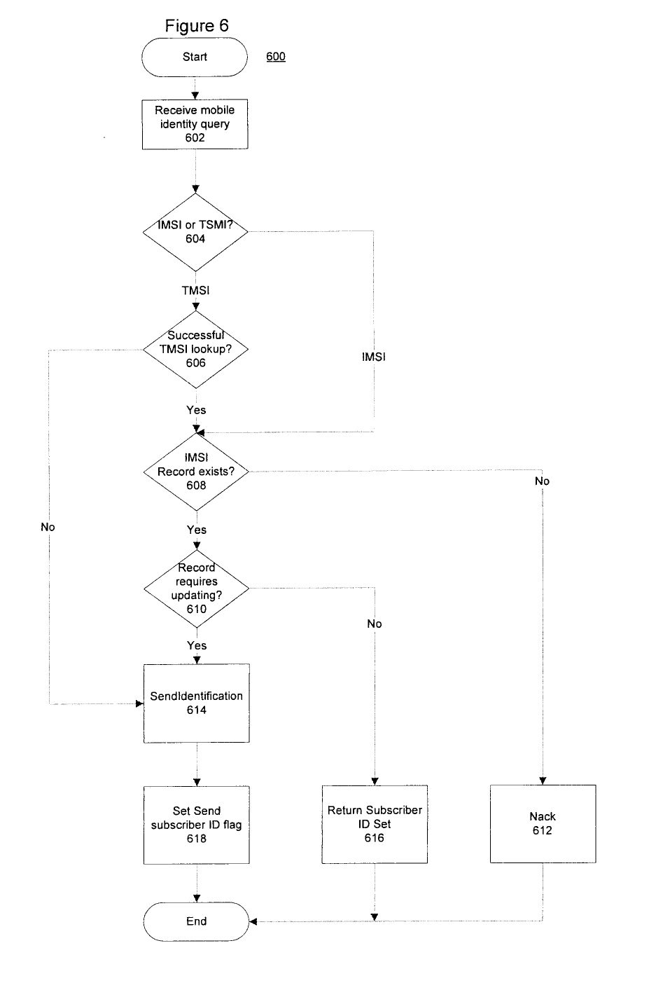

Referring to FIG. 6, process 600 for identification of subscriber from the perspective of the SIF begins at step 602 when it receives the mobile identity from the L2 Abis platform. Process 600 then continues to step 604 to identify a IMSI or a TSMI included in the query to check if a record is located in the data store. The subscriber records stored in the SIF data store are crossed indexed using two unique addresses: 1) a TSMI and origination address of the L2 Abis platform, 2) IMSI. In an illustrative embodiment, the IMSI is used as the primary key of the data store. TMSI and the origination address of the L2 Abis platform together form a unique address. The SIF performs a lookup of the subscriber based on one of the two subscriber addresses. Most queries from the L2 Abis platform are performed based on TMSI, not IMSI. Therefore, the SIF data store is performance tuned for TMSI and the origination address lookups.

If IMSI is included in the request, process 600 then continues to step 608 to determine if the IMSI record exists in the data store. However, if the TMSI is used, process 600 then continues to step 606 to determine if the TMSI lookup of record is successful. If the TSMI lookup is unsuccessful, it does not necessarily mean that the MO-SM offload service is not available, since the subscriber may have moved to another geographical area and the TSMI and origination address lookup failed as a result. Process 600 continues to step 614 to identify the subscriber's IMSI associated with the TMSI by initiating an external sendIdentification request. The SIF may be configured to perform an external lookup of every mobile identity request. The external lookup may ensure accurate billing of the MO-SM offload service to the final destination address. The external lookup checks the TMSI to IMSI correlation with an external system, such as a VLR.

If the lookup of the TMSI record is successful, process 600 proceeds to step 608 to locate the IMSI record in the data store. If a record is located in the data store using IMSI, the MO-SM offload service is available to the subscriber. If no record is located in the data store using IMSI, the MO-SM offload service is not available to the subscriber. If no IMSI record is located in the data store, a Nack is returned at step 612, since the MO-SM offload service is not available to the subscriber. If the IMSI record is located in the data store, process 600 proceeds to determine if the record requires updating. If the record requires updating, process 600 continues to step 614 to perform an external lookup by initiating a SendIdentification request.

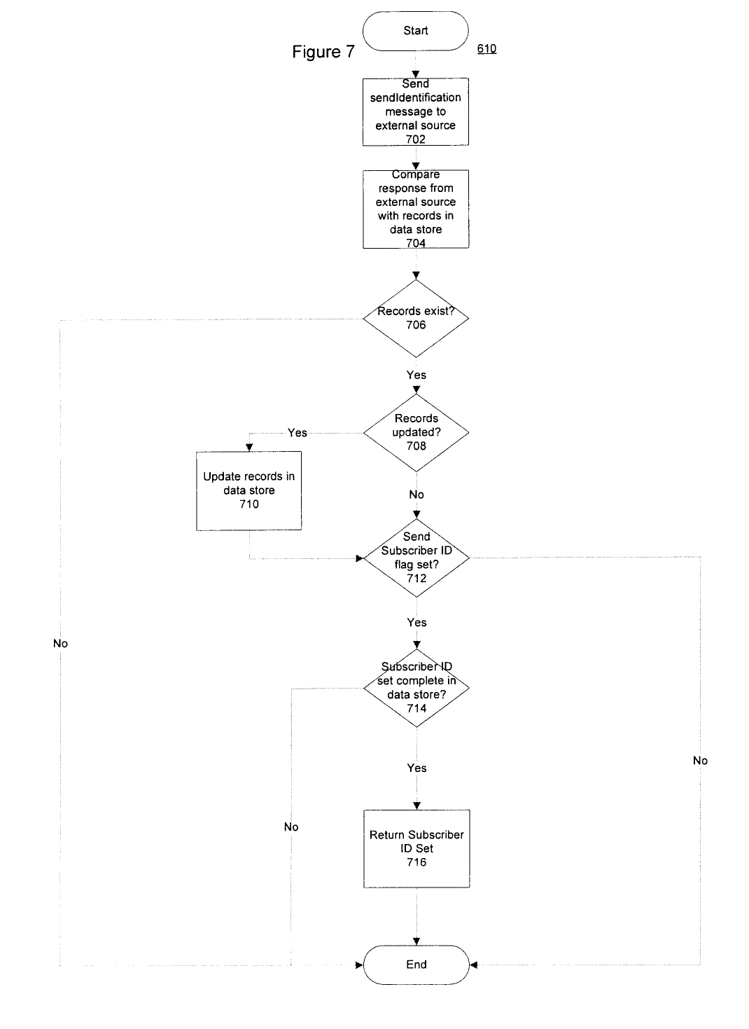

To ensure proper billing, the SIF keeps the subscriber identification information accurate and updated by using a sendIdentification MAP request. SendIdentification request is sent by SIF to either verify the current record or create a new record for a subscriber. The request is forward to an appropriate real time network node that can respond to the request. For example, a MAP sendIdentication message may be sent to the serving VLR. In response, the IMSI and the authentication set are returned. The MSISDN is updated via an OAM&P system or by monitoring the HLR to VLR MAP procedures. In another example, a sendIdentication request may be sent to an OAM&P system that maintains the IMSI, MSISDN, and Ki. The SIF may use the Ki to create an authentication set for the mobile station. In yet another example, the L2 Abis platform may send copies of specific messages to a monitoring node that correlates TMSI and IMSI along with storing previously used authentication sets. More details regarding SendIdentification request are discussed with reference to FIG. 7 below.

After the SendIdentification request is sent, process 600 proceeds to step 618 to set the “send subscriber ID” flag to hold a transaction open with the L2 Abis platform. The “send subscriber ID” flag is set when a subscriber identification set request is sent to an external source. The flag is later used by SIF to send a response back to the L2 Abis platform. If the record does not require updating, process 600 continues to step 616 to return the subscriber identification set to L2 Abis platform.

Referring to FIG. 7, process 610 for performing SendIdentication Request by the SIF begins at step 702 to send a sendIdentification message to the external source. In addition to performing a lookup, a sendIdentification message may be sent for periodic data integrity check. If a sendIdentification request is received, the SIF processes incoming responses continuously and in real time. If a response is received from the external source, process 610 continues to step 704 to compare with the data in the data store and determines if a record exists in the data store at step 706. If no record exists, the process terminates. If the record exists, process 610 continues to step 708 to determine if the records are updated in the data store. If the records are not updated, process 610 continues to step 712 to determine if the “send subscriber ID” flag is set.

If the records are updated, process 610 continues to step 710 to update and store the updated record in the data store and proceeds to step 712 to determine if the “send subscriber ID” flag is set. The “send subscriber ID” flag is set when the SIF has a pending request from the L2 Abis platform for the subscriber. If the “send subscriber ID” flag is not set, process 610 terminates. However, if the “send subscriber ID flag” is set, process 610 continues to step 714 to determine if the subscriber identification set is complete in the data store. If the subscriber ID set is incomplete, process 610 terminates. If the subscriber ID set is complete, process 610 proceeds to step 716 to return the subscriber identification set to L2 Abis platform.

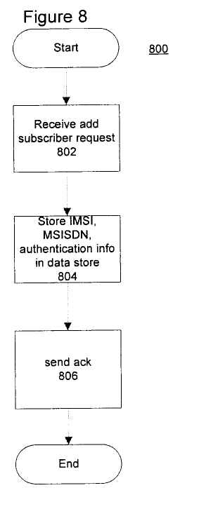

In addition to sendIdentification request, the SIF may perform other functions to maintain its list of subscribers. For example, adding a subscriber and removing a subscriber from the list. Referring to FIG. 8, process 800 for adding a subscriber performed by SIF begins at step 802 to receive an add subscriber request. The add subscriber request may be received at any time and independent of the L2 Abis platform requests. This capability allows the OAM&P system to update the SIF as the network and subscriber services change. The add request should contain at least the subscriber's IMSI and may include the MSISDN. Next, process 800 continues to step 804 to store information of the add request, including the IMSI, the MSISDN, authentication information, in the data store. Process 800 then continues to step 806 to send an acknowledgement (ack) to the originator of the request upon successfully adding the subscriber to the data store.

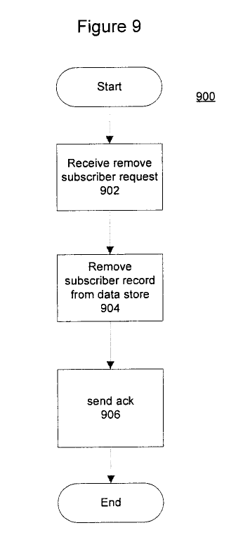

Referring to FIG. 9, process 900 for removing a subscriber performed by the SIF begins at step 902 to receive a remove subscriber request. The remove subscriber request may be received at any time and independent of the L2 Abis platform requests. This capability allows the OAM&P system to update the SIF as the network and subscriber services change. Process 900 then continues to step 904 to remove subscriber record from the data store. By removing the subscriber record, the MO-SM offload service is disabled from the subscriber. In addition, the OAM&P system may update the subscriber records by removing them and adding them back with updated information. Process 900 then continues to step 906 to send an acknowledgement (ack) to the originator of the request upon successfully removing the subscriber from the data store.

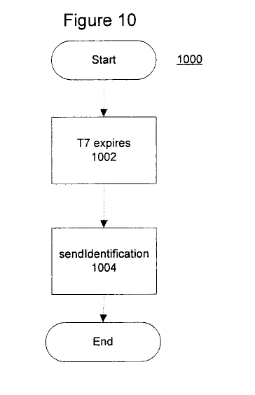

As discussed above, the SIF may automatically perform a period update of the records. Referring to FIG. 10, process 1000 for a periodic update of records in the data store by the SIF begins at step 1002 when the timer 7 expires. Timer 7 (T7) is used for timing records of the SIF data store. Each record in SIF includes a time-to-live (TTL) field. If the TTL expires, the record is automatically updated. After the record is updated, the TTL is reset. This capability prevents the records in the SIF record to become stale.

### Monitoring Radio Resource of Interest by the L2 Abis Platform

As discussed in FIG. 4, upon successful subscriber identification and authentication, the L2 Abis platform monitors the radio resource of interest in order to offload the MO-SM traffic. Referring to FIG. 11, process 424 for monitoring radio resource begins at step 1102 to screen messages on the data link connections based on the specific radio resource and the message type. To screen messages by the specific radio resource, the terminal endpoint identifier (TEI), sub-channel number, channel type, SAPI, and message discriminator of the radio link layer management (RLM) messages are used as key values to determine a radio resource of interest. The L3 message groups include radio link layer management messages (RLL), dedicated channel management messages (DCM), common channel management messages (CCM), TRX management messages, and location services messages. Since only a subset of the RLM messages requires monitoring, the message type information element (IE) is next screened. Since screening is performed on elements that have fixed values and are addressable by byte offset, the screening of messages may be implemented as software (via partial or full decode of the message) or firmware.

Process 424 then proceeds to step 1104 to determine if the message type is a type of RLL messages requiring monitoring. If the message type is not a type of RLL messages requiring monitoring, process 424 continues to step 1108 to determine if the message type is a DCM or a CCM message. Since DCM or CCM messages may modify the current radio resource of interest or page the subscriber, these messages are queued and passed to the BTS or BSC only after the MO-SM is offloaded or aborted. By queuing these messages, MO-SM offload service may be performed while still allowing the network to manage the subscriber and radio resources.

If the message type is not a DCM or CCM message, process 424 continues to step 1110 to place back on the Abis interface for immediate processing by the BSC or BTS, since it does not affect the MO-SM offload service. However, if the message type is a DCM or CCM message, process 424 continues to step 1180 to set the “MS message pending flag”, such that the DCM or CCM message is processed after the MO-SM offload is complete. Process 424 then returns to step 1102 to screen more messages.

Turning back to step 1104, if the message type is a RLL message requiring monitoring, process 424 continues to decode the RLL message. To decode layer 3 messages, the decoder of the RLL message is capable of reading common syntax notation (CSN), since the format of the L3 message is defined by CSN. To decode layer 2 messages, the decoder uses the LAPD specification, for example, the Q.920 or Q.921 standard.

The decoded message may be an authentication response. The authentication response is a mobility management message that is sent in response to the L2 Abis platform initiating the authentication procedure with the mobile station. The authentication response message is sent within a L3 DATA IND message and contains a SRES, which is RAND encrypted by Ki. If the decoded message is an authentication response, process 424 continues to 1112 to stop timer 3 (T3). T3 is used for timing authentication response from the MS. Process 424 then continues to determine if the SRES is equal to the RES. SRES is the response from the mobile station and RES is the expected response received from the SIF.

If SRES is not equal to the RES, authentication has failed and results in a failure condition. If authentication has failed, process 424 continues to release radio resource monitoring at step 1124. However, if SRES is equal to the RES, the MS is authenticated and process 424 continues to step 1116 to determine if the operator has configured the system to encrypt the MO-SMS traffic from the MS. The encryption may be configured on a system-wide basis or encryption information may be included in the subscriber identification set received from the SIF. If no encryption is configured, process 424 continues to step 1126 to start timer 1 (T1), which is used for timing CP-data sent from the MS.

If encryption is configured, process 424 continues to step 1118 to send an encryption command (ENCR CMD) to the BTS. The ENCR CMD is a dedicated channel management command and is processed by the BTS. This command includes sending a complete CIPH MOD CMD message to the MS. Process 424 then continues to step 1120 to start timer 4 (T4). T4 is used for timing the cipher code completion from the MS. Process 424 then returns to step 1102 to screen more messages.

If T3 for authentication response or T4 for cipher mode complete expires, an error condition has occurred. Process 424 continues to step 1122 to set the “continue CM-SERV-REQ” flag to indicate possible continuation of the stored CM-SERV-REQ and continues to step 1124 to release radio resource monitoring.

The decoded message may also be a cipher mode complete message from the MS. The cipher mode complete message may be in response to an ENCR CMD message sent by the L2 Abis platform. The L2 Abis platform sends the ENCR CMD message to the MS only after either the authentication is complete and that the encryption is configured for the subscriber or system. After receiving the cipher mode complete message, the radio resource is encrypted and the L2 Abis platform waits for CP-Data from the MS. Process 424 then continues to step 1130 to stop timer 4 (T4), since the cipher mode complete is received. Process 424 then continues to step 1132 to start timer 1 (T1) for timing CP-Data to be received from the MS. Process 424 then returns to step 1102 to screen more messages.

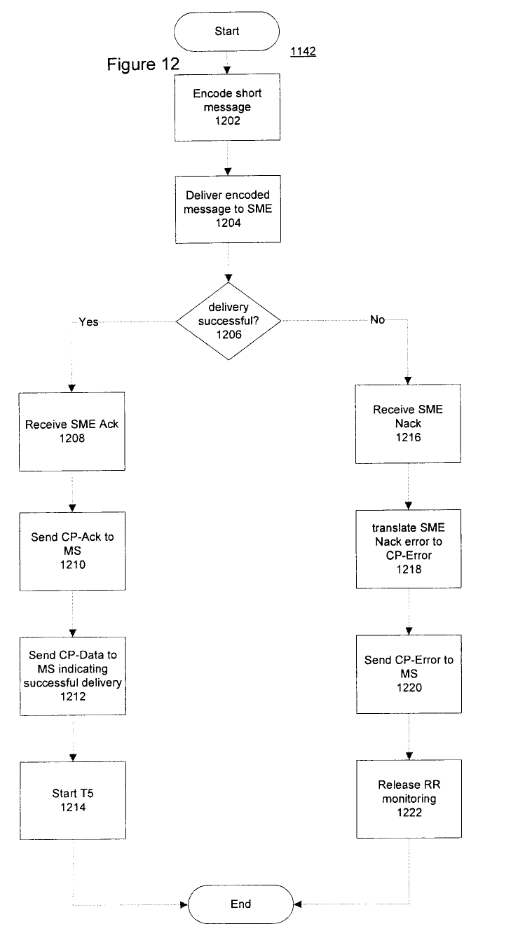

The decoded message may be CP-Data received from the MS containing the transaction protocol data unit (TPDU), which is the end-to-end short message PDU. The TPDU contains the destination address, encoding information, segmentation information and the short message text itself (or payload). Upon receipt of CP-Data, process 424 continues to step 1140 to stop timer 1 (T1) if only one CP-Data is sent or timer 6 (T6) if more than one CP-Data is sent. T6 is used for timing the next MO-SM. Process 424 then continues to step 1142 to perform the short message service routing function. The SMSRF attempts to offload the message received from the MS based on routing tables and subscriber data of the SIF. More details regarding the SMSRF are discussed with reference to FIG. 12 below.

If the timer 1 (T1) expires or an error condition is encountered, the MO-SM is not received and process 424 continues to step 1150 to deactivate the radio resource by performing release radio resource monitoring. If the MO-SM is successfully offloaded, a CP-Data is sent by the L2 Abis platform to the MS. In response, the MS sends a CP-Ack or a CP-Error to the L2 Abis platform. Even if a CP-Error is returned, the L2 Abis platform considers the delivery successful. If a CP-Ack or CP-Error is received, process 424 continues to step 1160 to start timer 6 (T6) to wait for a period of time for additional mobile originated short messages before potentially deactivating the radio resource.

If a timer 5 (T5) for timing CP-Ack or timer 6 (T6) for timing additional MO-SMs expires, process 424 continues to step 1170 to release radio resource monitoring and deactivate the radio resource. Even if no CP-Ack is returned, the L2 Abis platform considers the delivery is successful.

If other RLL or L3 messages are received, process 424 continues to step 1180 to set “MS message pending” flag. The “MS message pending” flag indicates that there are pending messages in the queue to be processed after the MO-SM is offloaded. When the flag is set, the radio resource is not deactivated during release radio resource monitoring until the MO-SM is offloaded.

### Short Message Service Routing Function (SMSRF)

The SMSRF may reside on the L2 Abis platform or be remotely accessible via a protocol such as TCP/IP. The SMSRF receives TPDUs along with the MSISDN and IMSI of the subscriber. The SMSRF encapsulates the TPDU into a protocol data unit for transport. The SMSRF may support various short message formats, including SMPP, MAP over SS7, MAP over SIGNTRANs, and other industry accepted short message transport solutions. The SMSRF attempts to deliver the short message to its final destination based on dynamically provisioned routing tables. It communicates success or failure to the L2 Abis platform in real time.

Referring to FIG. 12, process 1142 for short message routing function begins at step 1202 to encode the short message. The short message is encoded using the TPDU received from the MS along with MSISDN and/or IMSI received from SIF. The information is bundled into a PDU formatted correctly for the short message entity (SME), which may be any entity including short message service center (SMSC), an external application, or application server. Process 1142 continues to step 1204 to deliver encoded message to SMEs by utilizing a routing table based on the originating address, destination address, text or a combination thereof. The protocol used by the SMSRF to offload the short message may include SMPP, M3UA, MTP3, CIMD2, SMTP, or HTTP.

Once the message is delivered, process 1142 continues to step 1206 to determine if the delivery is successful based on whether a SME acknowledgement is received. If the delivery is successful, process 1142 continues to step 1208 to receive a SME Ack. Process 1142 then continues to step 1210 to send a CP-Ack to the MS indicating successful receipt of the MO-SM and continues to step 1212 to send a CP-Data containing a TPDU to the MS, indicating successful delivery of the MO-SM. The format and data within the CP-Data are based on the SME Ack received from the SME. Process 1142 then continues to step 1214 to start timer 5 (T5) for timing CP-Ack from the MS. When the MS receives the CP-Data, it stops all timers and marks successful delivery of the short message.

However, if the delivery is unsuccessful at step 1206, process 1142 continues to step 1216 to receive a SME Nack. The format and data within the TPDU returned to the MS is based on the SME Nack. Process 1142 then continues to step 1218 to translate SME Nack error to CP-Error. CP-Error is a permanent or temporary short message error. Process 1142 continues to step 1220 to send the CP-Error to the MS indicating a failure of delivery of the MO-SM. Process 1142 then continues to step 1222 to release radio resource monitoring to deactivate the radio resource.

### Release Radio Resource Monitoring

Either due to an error condition or a successful offloading of MO-SM, the radio resource of interest is released once monitoring is no longer required. Referring to FIG. 13, process 1300 for release radio resource monitoring begins at step 1302 to check two flags: “continue CM-SERV-REQ” flag and “fail to the MSC” flag. The “continue CM-SERV-REQ” flag indicates that a failure condition has occurred and the CM-SERV-REQ may continue to the MSC based on the failure. The “fail to the MSC” flag indicates that an operator has configured the CM-SERV-REQ to continue to the MSC if it is set to true. However, a failure may still occur at the MSC. If the “fail to the MSC” flag is set to false, the operator has configured the CM-SERV-REQ to be dropped and the short message is unsuccessfully processed by the network. The MS then informs the subscriber that the delivery of short message had failed.

If the flags indicate that the CM-SERV-REQ to not continue to the MSC, process 1300 continues to step 1308 to determine if the “MS message pending” flag is set. However, if the flags indicate that the CM-SERV-REQ continue to the MSC, process 1300 continues to step 1304 to place the stored CM-SERV-REQ back on the Abis interface to the BSC. The message is placed using the TRX originating address and normal processing at the BSC occurs. The message is sent to the MSC via the A interface. The MSC will then initiate authentication and cipher procedures and attempt delivery of the short message.

Process 1300 then continues to step 1306 to set the “keep L2 link” flag to ensure that the radio resource is not deactivated by the L2 Abis platform since the CM-SERV-REQ is placed back on the Abis interface. Process 1300 continues to step 1308 to determine if the “MS message pending” flag is set. This flag is set if the L2 Abis platform receives messages either from the MS or BSC addressed to or from the radio resource used during short message offload. Thus, additional services are utilizing the same radio resource of interest and the radio resource should not be deactivated until these services are completed.

If the “MS message pending” flag is not set, process 1300 continues to step 1312 to determine if the “keep L2 link” alive flag is set. However, if the “MS message pending” flag is not set, process 1300 continues to step 1310 to set the “keep L2 link” flag to keep the radio resource alive since there are messages pending for the radio resource. Process 1300 then continues to step 1312 to determine if the “keep L2 link” flag is set. If the “keep L2 link” flag is not set, the radio resource should be deactivated. Process 1300 continues to step 1313 to send a channel release message to the MS to release the radio resource. At this time, the L2 Abis platform also informs the BTS to deactivate the dedicated control channel of the active channel. However, if the “keep L2 link” is not set, process 1300 continues to step 1314 to remove the radio resource from the “monitor RR list”, which stops radio resource monitoring. Once the radio resource is removed, process 1300 continues to step 1316 to clean up the data store. Process 1300 then continues to step 1318 to place the pending messages on the Abis interface and finally continues to step 1320, which returns to step 404 to search the data link connections for other CM-SERV-REQ messages.

In summary, aspects of the present disclosure provide a system and a method for offloading mobile-originating short message traffic from the radio resource by providing a L2 Abis platform that is located between the BSC and the TRX of the BTS. The L2 Abis platform provides the capability to identify the MO-SMS request, to support mobility management and radio resource control, to transparently insert and remove radio signaling link traffic from the data link connections, to intercept and reroute MO-SMS traffic from the radio resource of interest, to properly encode SMS over IP PDUs, to support CM-SERV-REQ with a SAPI=3 and CP-Data from the MS, and to release the radio resource after offloading. In addition, a subscriber identification function is provided to correlate TMSI to IMSI in order to apply MO-SM offload service to the correct subscriber, which enables the association of a specific radio resource to a subscriber. The subscriber identification function also provides authentication sets to enable the L2 Abis platform to perform authentication procedures. It is noted that the L2 Abis platform and the SIF may be implemented as a software component or firmware component that supports L2 and L3 messages.

What is claimed is:

1. A method for managing mobile-originating short messages in a mobile communications network, the method comprising:
identifying a request for short message service in a plurality of data link connections;
identifying a subscriber for the request for short message service;
monitoring a radio resource for the subscriber; and
offloading short messages originating from the radio resource for the subscriber.

2. The method of claim 1, wherein identifying the request for short message service comprises:
searching in the plurality of data link connections for a connection management service request, wherein the connection management service request comprises a connection service type for a short message service; and
storing the connection service request having the connection service type for a short message service.

3. The method of claim 1, wherein identifying the subscriber for the request for short message service comprises:
sending a mobile identity request to a subscriber identification function; and
in response to receiving a subscriber identification set, adding the subscriber to a list of subscribers for monitoring.

4. The method of claim 1, wherein identifying the subscriber for the request for short message service comprises:
sending a mobile identity request to a subscriber identity function; and
in response to a stopping or an expiration of a timer for timing subscriber identification, returning a no-acknowledgement (Nack).

5. The method of claim 1, wherein identifying the subscriber for the request for short message service comprises:
in response to receiving a mobile identity request, determining if the request comprises one of a temporary mobile subscriber identity (TMSI) and a international mobile subscriber identity (IMSI).

6. The method of claim 5, wherein identifying the subscriber for the request for short message service further comprises:
if the request comprises a TMSI, performing a lookup of the subscriber in a data store using the TMSI; and
performing an external lookup if the lookup of a record of the subscriber in the data store is unsuccessful.

7. The method of claim 5, wherein identifying the subscriber for the request for short message service further comprises:
if the request comprises a IMSI, performing a lookup of a record of the subscriber in the data store using the IMSI; and
if the record of the subscriber is not located in the data store, returning a no-acknowledgement (Nack).

8. The method of claim 7, wherein identifying the subscriber for the request for short message service further comprises:
if the record of the subscriber is located in the data store, determining if the record requires updating;
if the record requires updating, performing an external lookup; and
holding a transaction open for offloading.

9. The method of claim 8, wherein identifying the subscriber for the request for short message service further comprises:
if the record does not require updating, returning a subscriber identification set of the subscriber.

10. The method of claim 6, wherein performing an external lookup comprises:
sending a request to an external source;
responsive to receiving a response from the external source, comparing the response with records in the data store;
determining if a record exists in the data store for the response;
if the record exists in the data store, determining if the record is updated; and
if the record is not updated, performing an update of the record in the data store.

11. The method of claim 10, wherein performing an external lookup further comprises:
determining if a transaction is held open; and
returning a subscriber identification set of the subscriber if the transaction is held open.

12. The method of claim 1, wherein monitoring a radio resource for the subscriber comprises:
screening a message on the plurality of data link connections based on the radio resource;
screening the message based on a message type to determine if the message requires monitoring; and
decoding the message requiring monitoring for the radio resource.

13. The method of claim 12, wherein screening a message on the plurality of data link connections based on the radio resource comprises:
identifying a radio resource of interest based on at least one of a terminal endpoint identifier (TEI), a sub-channel number, a channel type, a SAPI, and a message discriminator of radio link layer management (RLM) messages.

14. The method of claim 12, wherein screening the message on the plurality of data link connections based on a message type to determine if the message requires monitoring comprises:
determining if the message type of the message is a radio link layer management message requiring monitoring;
if the message type of the message is not a radio link layer management message requiring monitoring, determining if the message type of the message is one of a dedicated channel management message (DCM) and a common channel management message (CCM); and
if the message type is one of a dedicated channel management message and a common channel management message, processing the message after offloading is complete.

15. The method of claim 12, wherein decoding messages requiring monitoring for the radio resource comprises:
determining if the message is an authentication response from a mobile station;
stopping a timer for timing authentication response from the mobile station;
determining if the authentication response equals to an expected response; and
if the authentication response equals to the expected response, determining if encryption of the message is configured.

16. The method of claim 15, wherein decoding messages requiring monitoring for the radio resource further comprises:
if encryption of the message is configured, sending a cipher mode complete message to the mobile station and starting a timer for timing cipher mode completion; and
if encryption of the message is not configured, starting a timer for timing data sent from the mobile station.

17. The method of claim 12, wherein decoding messages requiring monitoring for the radio resource comprises:
determining if data is received from a mobile station; and
performing a short message service routing function.

18. The method of claim 17, wherein performing a short message service routing function comprises:
encoding the message to form a protocol data unit;
delivering the protocol data unit to a short message entity; and
determining if delivery of the protocol data is successful.

19. The method of claim 18, wherein determining if delivery of the encoded message is successful comprises:
determining if a short message entity acknowledgement is received;
sending an acknowledgement to the mobile station; and
sending a data message to the mobile station indicating successful delivery.

20. The method of claim 18, wherein determining if delivery of the encoded message is unsuccessful comprises:
determining if a short message entity no-acknowledgement (Nack) is received;
translating the short message entity no-acknowledgement (Nack) to an error message; and
sending the error message to the mobile station.

21. The method of claim 1, further comprising:
release monitoring of the radio resource after offloading the short messages.

22. The method of claim 21, wherein release monitoring of the radio resource after offloading comprises:
determining if at least one message is pending; and
placing the at least one message pending on the data link connection.

23. The method of claim 21, wherein release monitoring of the radio resource after offloading further comprises:
holding a transaction open;
removing the radio resource from a list of subscribers for monitoring;
cleaning up a data store of subscribers; and
identifying another request for the short message service.

24. The method of claim 21, wherein release monitoring of the radio resource after offloading comprises:
releasing a channel for the radio resource.

25. The method of claim 1, further comprising:
performing authentication of the subscriber.

26. A method for offloading mobile-originating short messages in a mobile communications network, the method comprising:
establishing a plurality of data link connections between a transceiver of a base transceiver station and a base station controller;
searching the plurality of data link connections for a request for short message service;
performing a lookup of subscriber identification information of a subscriber for the request;
performing authentication of the subscriber using the subscriber identification information;
in response to successful authentication of the subscriber, monitoring a radio resource for the subscriber;
in response to receiving a short message initiated by the radio resource, encoding the short message into a protocol data unit using the subscriber identification information;
forwarding the protocol data unit to a destination short message entity;
processing other pending messages received during the encoding and forwarding steps; and
releasing the radio resource for the subscriber.

27. A system for managing mobile-originating short messages in a mobile communications network comprising:
at least one mobile station;
at least one mobile switching center; and
at least one communication platform between the at least one mobile station and the at least one mobile switching center, the at least one communication platform is operable to identify a request for short message service, to identify a subscriber for the request for short message service; to monitor a radio resource for the subscriber, and to offload short messages originating from the radio resource for the subscriber.

28. The system of claim 27, wherein the at least one communication platform is a link access protocol channel D device on an Abis platform between the at least one mobile station and the at least one mobile switching center.

29. The system of claim 27, wherein the at least one communication platform maintains layer two status of a transceiver of a base transceiver station and a base station controller.

30. The system of claim 27, wherein the at least one communication platform is a fully functional layer two network node supporting terminal endpoint and network nodes to terminate data links between a transceiver of the base transceiver station and a base station controller.

31. A system for offloading mobile-originating short messages in a mobile communications network comprising:
at least one mobile station;
at least one mobile switching center; and
at least one communication platform between the at least one mobile station and the at least one mobile switching center,
the at least one communication platform is operable to establish a plurality of data link connections between a transceiver of a base transceiver station and a base station controller, search the plurality of data link connections for a request for short message service, perform a lookup of subscriber identification information of a subscriber for the request, perform authentication of the subscriber using the subscriber identification information, and monitor a radio resource for the subscriber responsive to successful authentication of the subscriber; and
a short message routing function accessible by the at least one communication platform, wherein the short message routing function is operable to encode the short message into a protocol data unit using the subscriber identification information responsive to receiving a short message initiated by the radio resource, and forward the protocol data unit to a destination short message entity,
wherein the at least one communication platform is further operable to process other pending messages received during the encoding and forwarding steps, and release monitoring of the radio resource for the subscriber.

32. The system of claim 31, wherein the at least one communication platform comprises the short message routing function.

33. The system of claim 31, wherein the short message routing function is accessible by the at least one communication platform remotely via a transmission control protocol/internet protocol (TCP/IP).
